(19) United States
(12) Patent Application Publication
(10) Pub. No.: US 2025/0196891 A1
(43) Pub. Date: Jun. 19, 2025

(54) VEHICLE SYSTEM

(71) Applicant: GM Global Technology Operations LLC, Detroit, MI (US)

(72) Inventors: Kevin W. Owens, Sterling Heights, MI (US); Benjamin Tran, Royal Oak, MI (US); James Doherty, Detroit, MI (US); Matthew Edward Gilbert-Eyres, Rochester Hills, MI (US); Russell A. Patenaude, Macomb Township, MI (US); Luke John Popiel, Oxford, MI (US); Snigdha Vuppalapati, Sterling Heights, MI (US)

(73) Assignee: GM Global Technology Operations LLC, Detroit, MI (US)

(21) Appl. No.: 18/542,647

(22) Filed: Dec. 16, 2023

(51) Int. Cl. B60W 60/00; G01C 21/36; G07C 5/00; G07C 5/08

(52) U.S. Cl. CPC B60W 60/0025; G01C 21/3679; G07C 5/006; G07C 5/0808; B60W 2530/00

(57) ABSTRACT

A vehicle system for a vehicle includes data processing hardware and memory hardware in communication with the data processing hardware, the memory hardware storing instructions that when executed on the data processing hardware cause the data processing hardware to perform operations including determining if the vehicle requires maintenance based on one or more of vehicle event data or contextual data, moving the vehicle from a first location to one or more vehicle maintenance stations based on a location of the vehicle, and returning the vehicle to the first location once vehicle maintenance is complete based on the vehicle location.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a vehicle system for detecting and addressing maintenance needs.

Vehicle maintenance is required throughout the life of a vehicle. For example, fluid levels such as fuel, oil, and washer fluid must be maintained within operating tolerances to ensure proper operation of the vehicle and, in some instances, to prevent damage to vehicle systems. Vehicle maintenance also includes proper maintenance of the appearance of the vehicle, which includes maintaining an interior and an exterior of the vehicle clean and free from debris. Maintaining the interior and the exterior of the vehicle clean and free from debris ensures that a vehicle operator is able to properly operate the vehicle. For example, cleaning a vehicle's windows allows the operator to see through the vehicle windows while driving and, thus, allows the operator have a clear vision of an area around the vehicle. Further, maintaining the interior and the exterior of the vehicle clean allows the vehicle operator to rely on vehicle sensors and cameras, which are able to properly function if not obstructed by dirt or other debris.

When a vehicle is initially manufactured, the vehicle is provided with a sufficient amount of fuel to allow the vehicle to be driven in and around a manufacturing facility and to be driven in and around a vehicle dealership. Further, newly manufactured vehicles are provided with oil, washer fluid, and all vehicle tires are inflated to allow the vehicle to be driven off of an assembly line of the manufacturing facility and onto a transport for delivery to a vehicle dealership. Finally, newly manufactured vehicles are often provided with protective coatings such as films on certain locations of the vehicle to protect the vehicle during transport from the manufacturing facility to the vehicle dealership.

While newly manufactured vehicles are provided with initial fluids and are generally operational once manufactured, vehicle dealerships are required to prepare new vehicles prior to delivery to a customer. Such preparation includes ensuring all fluid levels are within operating tolerances, ensuring tire pressure is within operating tolerances, removing films and other protective coatings from the vehicle, and washing the vehicle prior to final delivery to the customer.

The foregoing tasks are performed by personnel at the vehicle dealership and often require the vehicle to be moved from location to location to perform each service. For example, a vehicle must be driven from a vehicle transport to a gas station if additional fuel is required. If a tire requires additional air or the vehicle requires additional oil and/or washer fluid, the vehicle must be driven to one or more service bays at the dealership. Finally, the vehicle must be taken to a vehicle wash either at the vehicle dealership or remote from the vehicle dealership to have the interior and the exterior of the vehicle washed before the vehicle is delivered to the customer. Once delivered, vehicle maintenance becomes the responsibility of the vehicle owner.

While vehicle dealerships adequately prepare vehicles for delivery to a customer, the personnel and coordination required to prepare a vehicle for delivery is costly and time-consuming. Further, on-going maintenance of the vehicle by the vehicle owner may often be overlooked, as such maintenance may not be recognized as being needed or required. Accordingly, a need exists to simplify vehicle maintenance both during preparation of a vehicle for delivery by a vehicle dealership and after the vehicle is delivered to a customer.

### SUMMARY

In one configuration, a vehicle system for a vehicle includes data processing hardware and memory hardware in communication with the data processing hardware, the memory hardware storing instructions that when executed on the data processing hardware cause the data processing hardware to perform operations including determining if the vehicle requires maintenance based on one or more of vehicle event data or contextual data, moving the vehicle from a first location to one or more vehicle maintenance stations based on a location of the vehicle, and returning the vehicle to the first location once vehicle maintenance is complete based on the vehicle location.

The vehicle system may include one or more of the following optional features. For example, the processing hardware may be configured to issue a notification of completed maintenance once the vehicle is returned. The contextual data may include one or more of weather information, schedule information, visibility of the vehicle, and dealer information.

In one configuration, the vehicle event data may include data captured from one or more vehicle cameras or vehicle sensors. The vehicle sensors may include one or more of an optical sensor, an ultrasonic sensor, a proximity sensor, or a pressure sensor. Additionally or alternatively, the vehicle maintenance stations may include one or more of a car wash station, a battery charging station, a tire pressure station, and a vehicle light station. Finally, a vehicle may incorporate the vehicle system.

In another configuration, a vehicle system for a vehicle includes data processing hardware and memory hardware in communication with the data processing hardware, the memory hardware storing instructions that when executed on the data processing hardware cause the data processing hardware to perform operations including determining if the vehicle is above a desired dirt threshold based on one or more of vehicle location and vehicle event data and issue a notification if the vehicle is above the desired dirt threshold.

The vehicle system may include one or more of the following optional features. For example, the processing hardware may be configured to identify a car wash near a current route of the vehicle based on the vehicle location if the vehicle is above the desired dirt threshold. The vehicle location may include one or more of current vehicle location, past vehicle location, route information, and road conditions. Additionally or alternatively, the vehicle event data may include data captured from one or more vehicle cameras or sensors. The vehicle sensors may include one or more of an optical sensor, an ultrasonic sensor, a proximity sensor, or a pressure sensor. Finally, a vehicle may incorporate the vehicle system.

In yet another configuration, a vehicle system for a vehicle includes data processing hardware and memory hardware in communication with the data processing hardware, the memory hardware storing instructions that when executed on the data processing hardware cause the data processing hardware to perform operations comprising determining if the vehicle is above a desired dirt threshold based on one or more of vehicle location and vehicle event data, determining an optimal day, time, or location for vehicle washing based on the vehicle location and contextual data including one or more of weather information, schedule information, and car wash information, and issue a notification that the vehicle is above the desired dirt threshold and suggest optimal day, time, or location for vehicle washing.

The vehicle system may include one or more of the following optional features. For example, the vehicle location may include one or more of current vehicle location, past vehicle location, route information, and road conditions. Additionally or alternatively, the vehicle event data may include data captured from one or more vehicle cameras or sensors. The vehicle sensors may include one or more of an optical sensor, an ultrasonic sensor, a proximity sensor, or a pressure sensor.

In one configuration, the vehicle event data may include captured vehicle event data from nearby vehicles. Additionally or alternatively, the weather information may include one or more of past, current, or future precipitation information or past, current, or future pollen information. Finally, a vehicle may incorporate the vehicle system.

### BRIEF DESCRIPTION OF THE DRAWINGS

The drawings described herein are for illustrative purposes only of selected configurations and are not intended to limit the scope of the present disclosure.

FIG. 1 is an exterior view of a vehicle including a vehicle system according to one aspect of the disclosure;

FIG. 2 is an operational flow chart for the vehicle system of FIG. 1 according to one aspect of the disclosure;

FIG. 3 is an operational flow chart for the vehicle system of FIG. 1 according to one aspect of the disclosure; and

FIG. 4 is an operational flow chart for the vehicle system of FIG. 1 according to one aspect of the disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

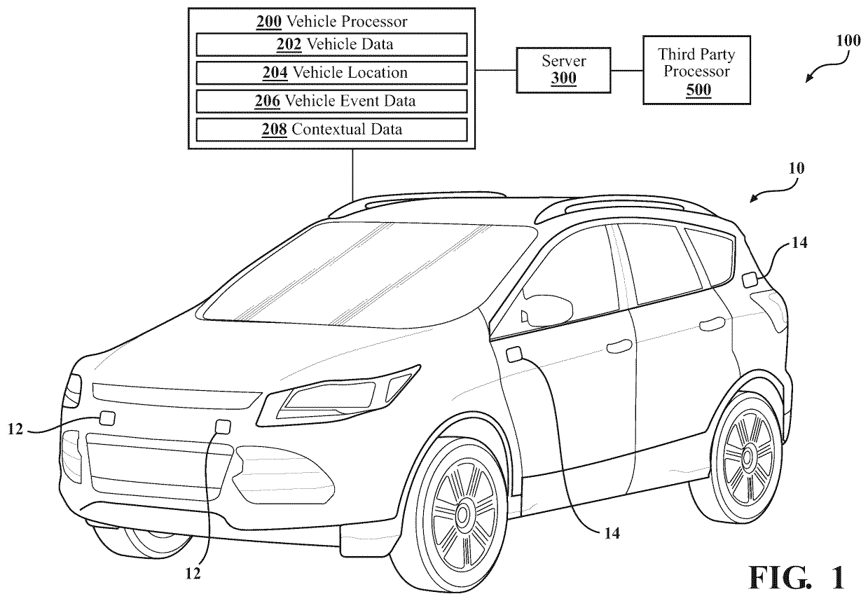

Referring now to FIGS. 1-4, a vehicle system 100 includes a vehicle processor 200 and a server 300 communicatively coupled with the vehicle processor 200. In FIG. 1, the vehicle system 100 is incorporated into a vehicle 10. The vehicle 10 maybe an electric vehicle 10 (EV) and may include autonomous or semi-autonomous capabilities. Alternatively, the vehicle 10 may include an internal combustion engine (ICE). Additionally, the vehicle 10 may be a hybrid vehicle 10 incorporating both EV and ICE components and capabilities. The vehicle 10 also includes a plurality of vehicle sensors 14 and/or vehicle cameras 12 configured to provide data to the vehicle processor 200. The vehicle sensors 14 may include one or more of an optical sensor, an ultrasonic sensor, a proximity sensor, or a pressure sensor.

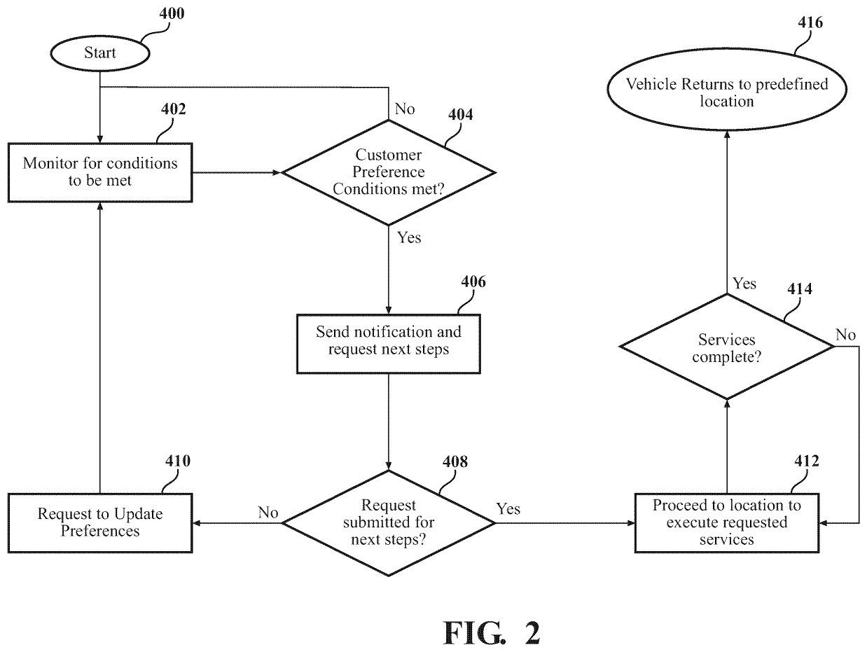

Referring again to the example illustrated in FIGS. 1-4, the vehicle processor 200 stores vehicle data 202 of the vehicle 10. While the vehicle processor 200 is described and shown as being a processor, the vehicle processor 200 may include processing hardware and memory hardware. The memory hardware allows the vehicle processor 200 to store data and instructions for instructing the processing hardware to perform the operations shown in FIG. 2, for example.

The vehicle data 202 includes one or more of vehicle location 204, vehicle event data 206, and contextual data 208. The vehicle location 204 generally pertains to a location of the vehicle 10. The vehicle location 204 may be gathered from a Global Positioning System (GPS) or other navigation system. Additionally or alternatively, the vehicle location 204 may be obtained from a third-party application or a user device such as a cellular phone or tablet. Regardless of how the vehicle location 204 is obtained or determined, the vehicle location 204 is communicated to the vehicle processor 200. Moreover, the vehicle location 204 may include route data such that a route the vehicle 10 is traveling along—including origin and destination information—may be communicated to the vehicle processor 200. Additionally, the vehicle location 204 may also include road data along the route including the type of road (i.e., dirt or paved), and road conditions such as wet or muddy roads along the route.

The vehicle event data 206 generally pertains to actions the vehicle 10 takes during operation including use of the vehicle cameras 12 and/or vehicle sensors 14. In some examples, the vehicle event data 206 may be gathered by one or more vehicle sensors 14 and/or vehicle cameras 12 and may be communicated to the vehicle processor 200 for storage and/or further processing. As described above, the vehicle sensors 14 may include one or more of an optical sensor, an ultrasonic sensor, a proximity sensor, or a pressure sensor and the vehicle processor 200 may receive data from one or more of the vehicle sensors 14. The vehicle event data 206 may include data from the optical sensors for light detection to analyze surfaces of the vehicle. Additionally, the vehicle event data 206 may include data from the ultrasonic sensors, which are configured to emit high-frequency sound waves and measure the time it takes for the sound waves to bounce back. A change in the time it takes to receive the high-frequency sound waves back to the sensor 14 can be used to identify changes in an outer surface of the vehicle 10. Namely, if an outer surface of the vehicle 10 includes built-up dirt or debris, the time required to receive the high-frequency sound waves back to the sensor 14 will change relative to a surface that is clean and free from dirt and debris. Accordingly, these sensors 14 can be used to determine whether—and to what extent—an outer surface of the vehicle 10 is covered by dirt and debris.

The vehicle data 202 may include data from the proximity sensors 14, which use electromagnetic field or infrared to detect added surface coverage. Additionally, the vehicle event data 206 may include data from one or more pressure sensors to detect build-up of dirt and other debris on vehicle surfaces. Moreover, the vehicle event data 206 may include visual data from the vehicle cameras 12, which may be used to detect dirt on the surface of the vehicle 10. Additionally, the vehicle event data 206 may include captured vehicle event data 206 from nearby vehicles. For example, the vehicle event data 206 may include captured camera data of a nearby vehicle with the camera data including visual images of the vehicle 10. All of this information may be used by the processor 200 in determining whether the vehicle 10 is dirty (i.e., the extent of the build-up of dirt and other debris on outer surfaces of the vehicle 10).

The vehicle data 202 also includes the contextual data 208. The contextual data 208 may include one or more of weather information, schedule information, information related to visibility of the vehicle, dealer information, and car wash information. For example, the weather information generally pertains to one or more of past, current, or future precipitation information, past, current, or future pollen information, or past, current, or future temperature conditions. The weather information may be obtained or sensed by the vehicle cameras 12 and/or sensors 14 or may be gathered through other means such as through a third-party processor 500, described in more detail below. Additionally, schedule information may relate to a user schedule such as the time and place of a meeting the driver will attend. The schedule information may be inputted by the owner, learned by the vehicle 10 over time, or may be accessed by the vehicle processor 200 and/or the server 300 through an application on a user device such as a cellular phone or tablet. Additionally, the visibility of the vehicle 10 generally pertains to the location where the vehicle 10 is parked. For example, the visibility of the vehicle 10 may relate to whether the vehicle 10 is waiting at a dealership to be sold and whether the vehicle 10 is visible from a nearby road such that the dealership or owner of the vehicle 10 may desire to keep the vehicle 10 clean to attract potential buyers. Additionally, dealer information may relate to information related to selling the vehicle 10 including, but not limited to, dealership sales data, sales targets, upcoming specials, and number of vehicles on a lot of the vehicle dealer along with their locations within the lot. Moreover, the car wash information generally pertains to anything related to car washes, which may be available along a route. The car wash information may include, but is not limited to, car wash locations, car wash hours, loyalty or membership information, car wash traffic, and/or car wash prices.

With further reference to FIGS. 1-3, the server 300 is configured as a network and/or a cloud-based system that communicates with the vehicle processor 200. It is also contemplated that the vehicle processor 200 may communicate any or all of the vehicle data 202 to the server 300 for further processing and/or evaluation. The vehicle processor 200 and/or the server 300 may continuously and/or regularly update such that the vehicle data 202 is updated in real-time.

The server 300 may also be configured to communicate with third-party processors 500 to collect third-party data. For example, the third-party processors 500 may include, but are not limited to, other vehicle processors 200 along the route. Additionally or alternatively, the third-party processors 500 may include third-party user devices within vehicles 10 along the route such as cellular phones and tablets. Further, additional vehicle data 202 may be obtained by the server 300 through third-party processors 500 as crowdsourced information such that one or more of the vehicle location 202, the vehicle event data 206, and the contextual data 208 is gathered from nearby vehicles 10, or other vehicles 10 along the route. More specifically, crowdsourced information from nearby vehicles 10 may be gathered through Bluetooth™, Wi-Fi™, third-party applications, or other similar methods. The vehicle location 204 may be crowdsourced from other vehicles 10 including, but not limited to, vehicle camera data pertaining to the vehicle 10 and/or current weather conditions of other vehicles along the route. Additionally, the server 300 may also be configured to access additional information from third-party processors 500 such as vehicle warranty or recall information, future and past weather information, time, day of the week, and date information. Moreover, the server 300 is configured to use the information from the third-party processors 500 as additional vehicle data 202 to help confirm or provide additional context to any of the vehicle data 202.

The server 300 may also be configured to create and update an owner preference profile. The owner preference profile may include current and previous owner preferences including preferred cleanliness level, number of preferred vehicle washes over a time period, and information related to previous cleanliness suggestions and whether the suggestion was effective such that the owner followed through with getting the vehicle 10 cleaned after the notification.

The vehicle system 100 as described herein is configured to determine if various maintenance tasks should be performed during all stages of the vehicle 10. For example, the vehicle system 100 provides for determination of whether various maintenance tasks should be performed prior to the vehicle 10 being sold (i.e., while the vehicle 10 is at a vehicle dealership), during the sale from the dealership, and after the sale of the vehicle 10 to a customer.

First, the server 300 may monitor the vehicle 10 prior to the vehicle being purchased such that the server 300 may be activated to provide maintenance to the vehicle 10 if one or more maintenance conditions are met. For example, the server 300 may provide periodic checks to the vehicle 10 including checking battery life, light check, and tire pressure status and may automatically activate maintenance based on the results of the checks. The maintenance conditions may be set by the server 300 and stored in the vehicle processor 200 and may include owner preferences from the owner preference profile. While the server 300 is described as monitoring the vehicle 10, the processor 200 could additionally or alternatively monitor the vehicle 10 for the foregoing maintenance requirements.

Further, the processor 200 and/or the server 300 is also configured to determine if the vehicle 10 requires maintenance based on one or more of the vehicle event data 206 or the contextual data 208. For example, the processor 200 and/or the server 300 may be configured to use the vehicle event data 206, such as data from one or more of the vehicle sensors 14 and/or cameras 12, to determine if the vehicle 10 is dirty and requires washing. Additionally, the determination of whether the vehicle 10 requires maintenance may be based on a maintenance threshold such that the processor 200 and/or the server 300 determines that the vehicle 10 needs maintenance if the processor 200 and/or the server 300 determines that the vehicle 10 is above the maintenance threshold based on one or more of the vehicle event data 206 and the contextual data 208. For example, the server 300 may use the contextual data 208, such that a dealership sale is upcoming and the vehicle 10 is located in a prime viewing spot on a dealership lot, along with the information from one or more of the vehicle sensors 14 and/or cameras 12 related to whether the vehicle 10 is dirty, to determine if the vehicle 10 should be washed. Additionally, the maintenance threshold may be raised or lowered by the contextual data 208. For example, the information that the dealership sale is upcoming and that the vehicle 10 is located in a prime viewing spot may lower the maintenance threshold such that it would be more likely for the server 300 to determine that the vehicle 10 needs maintenance (i.e., a car wash). Further, in some examples, the server 300 may automatically provide maintenance, such as a vehicle wash, after a certain time period has elapsed since the last vehicle wash.

The processor 200 and/or the server 300 may also be configured to activate the vehicle to 10 move to one or more vehicle maintenance stations based on the vehicle location 202. For example, the processor 200 and/or the server 300 may activate an autonomous driving system of the vehicle 10, which may direct the vehicle 10 to one or more vehicle maintenance stations. The vehicle maintenance stations may include one or more of a car wash station, a battery charging station, a tire pressure station, and a vehicle light station. In examples where the vehicle 10 does not include the autonomous driving system, the vehicle 10 may use a track system or a towing system to guide or otherwise move the vehicle 10 to the desired vehicle maintenance station. Additionally, once the vehicle 10 receives the desired maintenance at the vehicle maintenance station, the processor 200 and/or the server 300 may be configured to move the vehicle 10 to another vehicle maintenance station or may be configured to return the vehicle 10 to an original location or a new desired location once vehicle maintenance is complete. Moreover, processor 200 and/or the server 300 is further configured to notify a user, such as the owner or dealership representative, of completed maintenance once the vehicle 10 is returned. The notification may be displayed on a dashboard of the vehicle 10 or may be through a third-party application or other system.

Referring now to the example in FIG. 2, in operation, the vehicle 10 may begin operation at step 400 and the processor 200 and/or the server 300 will monitor for conditions to be met at step 402. While the processor 200 and/or the server 300 can perform the following functions shown in FIGS. 2-4, the server 300 will be described hereinafter as performing these functions. If the maintenance conditions are met at step 404, the server 300 will send a notification alerting the owner that the vehicle 10 is above the maintenance threshold and request next steps from the owner at step 406. If a response is not submitted by the user at step 408, the server 300 will update the user profile with the non-response at step 410 and continue monitoring at step 402. If a response is submitted by the owner at step 408 the vehicle 10 may direct the owner to proceed to a location to execute the requested services. Additionally or alternatively, if a response is submitted by the owner at step 408, the vehicle 10 may use autonomous driving capabilities to automatically move the vehicle 10 to the location of the desired services at step 412. The vehicle 10 then remains at the location of the desired service until it is determined that the service is complete at step 414 where the vehicle 10 may then be taken to another maintenance station, returned a desired location, or may resume the previous route at step 416.

Additionally or alternatively, the server 300 may be activated to automatically provide maintenance to the vehicle 10 by a third-party application or other indication to the server 300 that a customer purchase has occurred. More specifically, a dealership application may indicate to the server 300 that the vehicle 10 has sold at which point the server 300 may automatically activate maintenance to the vehicle 10. The server 300 may be configured to provide checks to the maintenance items to confirm their necessity, however, it is also contemplated that maintenance to all maintenance items will be completed once the customer purchase has occurred.

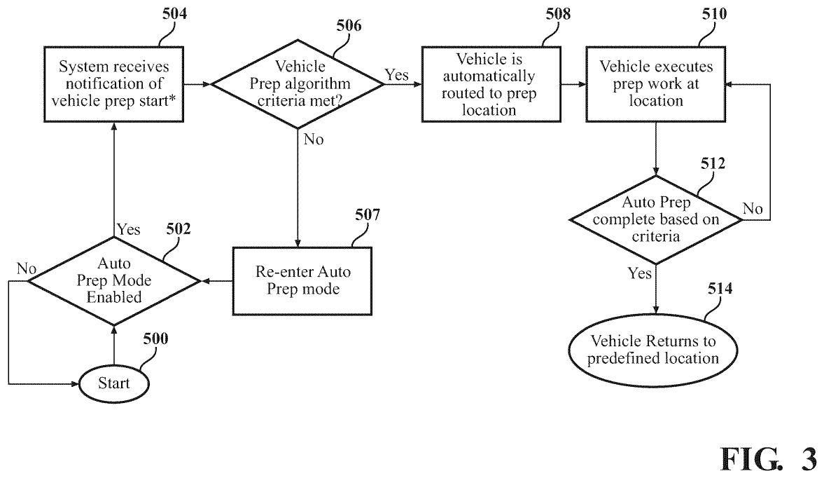

Referring now to the example shown in FIG. 3, in operation, the vehicle 10 may begin operation at step 500 and the server 300 determines if the vehicle system 100 is enabled at step 502 (i.e., if a purchase of the vehicle 10 has been completed). The server 300 may also receive a notification that the system 100 has started at step 504 and provide checks to determine if the vehicle preparation algorithm criteria (i.e., the maintenance threshold), has been met at step 506. If the criteria has not been met (i.e., none of the maintenance items are below the maintenance threshold), the server 300 is configured to continue monitoring at step 507. If the criteria has been met, the vehicle 10 is automatically routed to the maintenance station at step 508 and the maintenance is executed at step 510. The server 300 then determines if the preparation is complete at step 512. If the preparation is not complete, the vehicle 10 may return to another maintenance station to receive the required maintenance at step 510. Once the preparation is complete, the vehicle 10 then returns to the predefined location at step 514. The predefined location may be the original location or a new location in preparation for delivery to the customer.

Once delivery is complete, the vehicle system 100 is configured to assist the owner in keeping the exterior of the vehicle 10 at a desired level of cleanliness. More specifically, the server 300 is configured to determine if the vehicle 10 is above a desired dirt threshold based on one or more of vehicle location 202 and vehicle event data 206. For example, the server 300 is configured to use the vehicle event data 206 such as data from one or more of the vehicle sensors 14 and/or cameras 12 to determine if the vehicle 10 is above the desired dirt threshold (i.e., if the amount of built-up dirt and/or debris on an exterior surface of the vehicle 10 exceeds a predetermined amount). For example, the server 300 may use the data gathered from the vehicle sensors 14 and/or cameras 12, such as data showing one or more vehicle cameras 12 is dirty to determine if the vehicle 10 is above the desired dirt threshold. The dirt threshold may be raised or lowered by the contextual data 208. For example, the weather information may show that rain is in the forecast for the next day, which would raise the dirt threshold such that the server 300 would be less likely to suggest a car wash at this time. Additionally or alternatively, the dirt threshold may be set by the owner as a setting of the vehicle 10 in the owner profile and/or may be learned and improved over time and updated in the owner profile.

If it is determined that the vehicle 10 is above the dirt threshold, the server 300 may also be configured to notify the owner if the vehicle 10 is above the desired dirt threshold. For example, the notification may be through the dashboard of the vehicle 10 or through a notification on a user device such as a cellular phone or tablet coupled to the vehicle 10. Additionally, the server 300 may also be configured to notify the owner of a car wash location near the current route based on the vehicle location 202 if the vehicle 10 is above the desired dirt threshold. For example, if it is determined that the vehicle 10 is above the desired dirt threshold, the server 300 may use the route information from the vehicle location 202 to determine if there is a car wash location along or near the route, notify the owner of the car wash locations found, and/or suggest a route that includes the car wash location.

Further, the server 300 may also be configured to determine an optimal day, time, or location for vehicle washing based on the vehicle location 202 and the contextual data 208 including one or more of the weather information, the schedule information, and the car wash information. For example, the server 300 may use the vehicle location 202—based on the owner's schedule—to know that an upcoming usual route includes a dirt road. This information, along with contextual data 208 such as rain in the weather forecast in two days and a holiday in four days, for which the owner may want to have a clean vehicle, to determine that an optimal day for a car wash is three days from now. Further, the server 300 may also notify the owner that the vehicle 10 is above the desired dirt threshold or may be soon over the desired threshold based on vehicle location 202 and contextual data 208 and suggest the optimal day, time, and/or car wash location for vehicle washing. Additionally, the suggestion may be displayed on the dashboard or may be suggested to the owner in another manner including, but not limited to, a notification on the user device of the owner, a notification through a third-party application, and/or an audio notification.

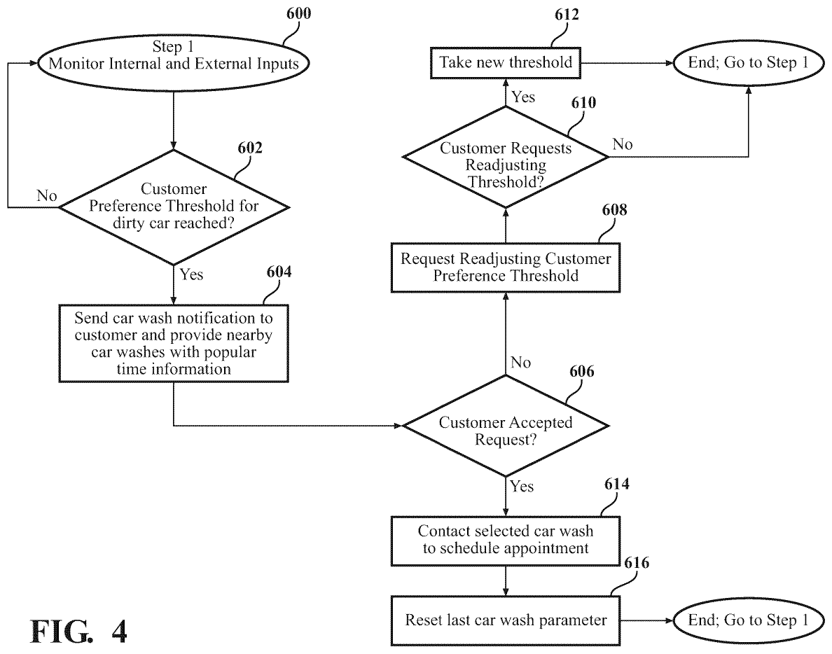

Referring now to the example shown in FIG. 4, the server 300 is configured to monitor external inputs (i.e., weather pattern, driving patterns, user inputs, vehicle location 202, car wash information, and time passed since last car wash) and internal inputs (i.e., road conditions, sensor input, camera input) at step 600. If the server 300 determines that the dirt threshold has been reached at step 602, the server 300 will send a car wash notification to the owner and provide the owner with nearby car wash locations along with operation information such as hours of operation at step 604. If the owner does not accept the request (i.e., the vehicle 10 is not taken to the car wash) at step 606, the server 300 will request to readjust the owner preference threshold in the owner profile at step 608. Additionally, if the owner requests readjusting the threshold at step 610, the server 300 will note the new threshold in the owner profile at step 612. However, if the owner does not request readjusting the threshold at step 610, then the server 300 will return to monitoring at step 600. Additionally, if the owner does accept the request at 606, the server 300 may take action at step 614 including, but not limited to, contacting the selected car wash location and scheduling an appointment. The server 300 will also reset the last car wash parameter at step 616 to reset the time passed since the last car wash once the car wash is completed. Once complete, the server 300 will continue monitoring at step 600.

The vehicle system 100 as described herein includes the vehicle processor 200 and the server 300 configured to store vehicle data 202, to determine if maintenance tasks should be performed, and to automatically perform the desired tasks. The vehicle system 100 is also configured to determine whether the vehicle 10 is dirty and direct the owner to the nearest car wash to clean the vehicle 10. As such, the vehicle system 100 removes human error from the preparation of a vehicle 10 to be delivered to a buyer and allows the owner to be notified when the vehicle 10 is above the desired dirt threshold.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicle system for a vehicle, the vehicle system comprising:
data processing hardware; and
memory hardware in communication with the data processing hardware, the memory hardware storing instructions that when executed on the data processing hardware cause the data processing hardware to perform operations comprising:
determining if the vehicle requires maintenance based on one or more of vehicle event data or contextual data;
activating the vehicle to move from a first location to one or more vehicle maintenance stations based on a location of the vehicle; and
returning the vehicle to the first location once vehicle maintenance is complete based on the vehicle location.

2. The vehicle system of claim 1, wherein the processing hardware is configured to issue a notification of completed maintenance once the vehicle is returned.

3. The vehicle system of claim 1, wherein the contextual data includes one or more of weather information, schedule information, visibility of the vehicle, and dealer information.

4. The vehicle system of claim 1, wherein the vehicle event data includes data captured from one or more vehicle cameras or vehicle sensors.

5. The vehicle system of claim 4, wherein the vehicle sensors include one or more of an optical sensor, an ultrasonic sensor, a proximity sensor, or a pressure sensor.

6. The vehicle system of claim 1, wherein the vehicle maintenance stations include one or more of a car wash station, a battery charging station, a tire pressure station, and a vehicle light station.

7. A vehicle incorporating the vehicle system of claim 1.

8. A vehicle system for a vehicle, the vehicle system comprising:
data processing hardware; and
memory hardware in communication with the data processing hardware, the memory hardware storing instructions that when executed on the data processing hardware cause the data processing hardware to perform operations comprising:
determining if the vehicle is above a desired dirt threshold based on one or more of vehicle location and vehicle event data; and
issue a notification if the vehicle is above the desired dirt threshold.

9. The vehicle system of claim 8, wherein the processing hardware is configured to identify a car wash near a current route of the vehicle based on the vehicle location if the vehicle is above the desired dirt threshold.

10. The vehicle system of claim 8, wherein the vehicle location includes one or more of current vehicle location, past vehicle location, route information, and road conditions.

11. The vehicle system of claim 8, wherein the vehicle event data includes data captured from one or more vehicle cameras or sensors.

12. The vehicle system of claim 11, wherein the vehicle sensors include one or more of an optical sensor, an ultrasonic sensor, a proximity sensor, or a pressure sensor.

13. A vehicle incorporating the vehicle system of claim 8.

14. A vehicle system for a vehicle, the vehicle system comprising:
data processing hardware; and
memory hardware in communication with the data processing hardware, the memory hardware storing instructions that when executed on the data processing hardware cause the data processing hardware to perform operations comprising:
determining if the vehicle is above a desired dirt threshold based on one or more of vehicle location and vehicle event data;
determining an optimal day, time, or location for vehicle washing based on the vehicle location and contextual data, the contextual data including one or more of weather information, schedule information, and car wash information; and
issue a notification to a vehicle owner that the vehicle is above the desired dirt threshold and suggest optimal day, time, or location for vehicle washing.

15. The vehicle system of claim 14, wherein the vehicle location includes one or more of current vehicle location, past vehicle location, route information, and road conditions.

16. The vehicle system of claim 14, wherein the vehicle event data includes data captured from one or more vehicle cameras or sensors.

17. The vehicle system of claim 16, wherein the vehicle sensors include one or more of an optical sensor, an ultrasonic sensor, a proximity sensor, or a pressure sensor.

18. The vehicle system of claim 14, wherein the vehicle event data includes captured vehicle event data from nearby vehicles.

19. The vehicle system of claim 14, wherein the weather information includes one or more of past, current, or future precipitation information or past, current, or future pollen information.

20. A vehicle incorporating the vehicle system of claim 14.
